(19) United States
(12) Patent Application Publication
(10) Pub. No.: US 2019/0375479 A1
(43) Pub. Date: Dec. 12, 2019

(54) Injury Preventative Handlebar Grip Maximizing Natural Grip Strength

(71) Applicant: Nathaneal Williams Adams, La Jolla, CA (US)

(72) Inventor: Bryce Hudson, Murrieta, CA (US)

(73) Assignee: Bryce Hudson, San Diego, CA (US)

(21) Appl. No.: 16/001,131

(22) Filed: Jun. 6, 2018

Related U.S. Application Data
(63) Continuation-in-part of application No. 29/650,363, filed on Jun. 6, 2018.

(51) Int. Cl. B62K 21/26

(52) U.S. Cl. CPC B62K 21/26

(57) ABSTRACT

A hyperbolic motorcycle handlebar hand grip made of a resilient material, intended for use of attaching onto horizontally placed handlebars as to place the wrist in a neutral holding position and as well as improving grip strength through length tension relationship properties of the middle, ring, and little finger(s).

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of recreation and injury prevention.

### Background of the Invention

Motocross is a form of off-road motorcycle riding. Often motocross can be a competitive sport, which involves riders traveling around closed courses with various jumps and other obstacles. Motocross can also be recreational, where riders cruise around the course for pleasure. In either context, motocross is an extreme sport and can be a dangerous and high-intensity sport that requires great stamina and athleticism.

Because the sport is dangerous, a steady, comfortable, and postured riding form is a primary concern. In particular, such riding form increases the rider's handling, stability, and reliability of the bike. Moreover, a mix of riding at high speeds and turns forces a rider to continually vary posture and handling position over the course of a ride. In view of the foregoing, many motorcycles are customized for the comfort, stability, strength, and reliability of a rider's grasp of the handlebars. For instance, a rider may use either (a) an aggressive posture (where the rider is standing with outstretched arms against the handlebars) (FIG. 1) at high speeds or while traversing rough terrain or (b) a relaxed posture (where the rider is seated upright and propped by outstretched arms against the handlebars) during slower or smoother rides (FIG. 2).

Appropriate handlebars are needed for accommodating various posturing of the rider and handling of the bike. For instance most motocross bikes use flat handlebars or, “flat bars.” Exemplary flat handlebars 2000 are shown in FIG. 3 and are typically a smooth tube or bar that is straight or slightly bent upward and toward the rider when positioned on the center clamp or handlebar stem of the motorcycle frame. Grasping the handlebars by the rider with optimal grip strength presently is one of the most important yet least addressed qualities for motorcycle handlebars. The ability to adequately grip motorcycle handlebars can make the difference between (i) a smooth and controlled ride with little fatigue in one case and (ii) an uncontrollable ride leading to muscle fatigue in another case. Adding jumps, speed, and uneven terrain to motocross riding demands a consistent hold that taxes and weakens a rider's grip strength. Plain handlebars are not ideal because the smooth surface does not result in adequate grip. So, motorcycle handlebars usually feature special grips.

FIG. 4 is an image of an image of a conventional or industry standard handlebar grip 1000 for a motorcycle. As shown, the majority of conventional handlebar grips 1000 are comprised of a hollow cylindrical body 1100 that defines a non-rotatable sleeve-like cap for the distal end of a handlebar 2000 (FIG. 3). Usually, conventional grips 1000 are made of flexible or cushion material, like rubber, and they have a hollowed-out interior (not shown) that opens out to one flanged end 1300 of the grip 1000. Handlebars 2000 are outfitted with the grip 1100 by inserting the handlebar 2000 into the hollowed-out interior of the grip 1100 until the handlebar 2000 internally abuts the cap end 1200 of the grip 1000.

As shown in FIG. 4, these conventional grips 1000 usually contain a constant diameter and tractioned outer surface defined by designs/layer projections to increase the friction of a user's grip and thereby minimize slippage. Because of ergonomics, a rider's hand 3000 in an aggressive or relaxed posture (FIGS. 1 and 2) has a tendency to float inward toward the middle of the handlebars 2000 during a ride. So, in most cases, the flange end 1300 defines an annular flange projecting radially and symmetrically outwards from around the opening of the interior cavity (not shown in FIG. 4) of the grip 1000. Still referring to FIG. 4, the annular flange 1300 is intended to provide an inner limit for a driver's hand 3000 wherein his/her forefinger and thumb encircle the grip and are blocked from advancing or floating toward the bare handlebar 2000 by the flanged end 1300 of the grip 1000. It is noteworthy that conventional grips 1000 do not have a flange on the cap end 1200, which configuration creates an opportunity for a rider's hand 3000 to move uncontrollably outwards off the terminal end of the grip 1000. In the jolt of a bump or obstacle, a rider's hand 3000 may slide off or outwards on the grip 1000. So, conventional grips 1000 are unsatisfactory because they do not resist movement of a rider's hand 3000 outwardly.

As shown in FIG. 4, conventional grips 1000 are also not entirely satisfactory because they position a rider's wrist 3000 for injury. The most common type of wrist 3000 fracture while riding occurs from an impact that hyper deviates the wrist 3000 so that the radial side of the hand is radially deviated towards the forearm. Such hyper deviations are common with traditional handlebar grips 1000 because handling the relatively constant diameter of the grip 1100 results in a radial deviation of the wrist 3000 in relation to the forearm. Such deviation is common with traditional handlebar grips 1000 because handling the relatively constant diameter of the grip 1100 results in movement of the wrist 3000 to an incorrect position that invites hyper deviation and injuries by impact forces during a bump. The wrist 3000 is basically situated to bend inward to the point of fracture or injury by hyper deviation. With such an incorrect wrist 3000 position, even when there are relatively low impact forces, a wrist 3000 joint is weakened and more vulnerable to forces either stretching or hyper deviating the joint past a normal range of motion or compressing any of the eight carpal bones, most notably the scaphoid and lunate bones, that comprise the wrist 3000 to the point of fracture. When the wrist 3000 is in this deviated position, any force that is placed on the joint will strain the joint further as the tendons and ligaments fight to prevent excessive movement of the joint. Previously designed grips, as shown in FIG. 4, too often encourage deviation of the wrist 3000, accelerating fatigue and weakening grip strength, leaving the joint vulnerable to a high impact or compression injury. This technical issue cannot be overcome with an increase in wrist strength but must rather be solved with a proper biomechanical wrist alignment.

Unlike a radially extended wrist position, a neutral wrist position is desirable when riding. A neutral position puts the wrist in an optimal position for stability wherein impact forces can be properly dispersed by all wrist stabilizer muscles working most efficiently. Grip strength can be increased so that muscle fatigue and injuries during motorcycle riding are reduced. Therefore, a need for improved handlebar grips exists where reduced radial deviation is accomplished to optimize fine motor control of the fingers and hand which can be augmented by an optimal position of the wrist.

All skeletal muscles have an optimal range of motion in which they are most efficient. Known as length-tension relationship, muscles exhibit varying levels of strength based upon their length when flexed. A study by the National Institutes of Health, evaluating the effects of handle grip strength, found that each finger exhibits a different optimal grip span which creates this optimal resting length for maximum individual finger contribution to overall grip strength. Further, the study found that when contributing individual finger force, the middle finger showed the highest contribution followed by the ring, index, and little finger respectively. Therefore, altering the circumference of a handlebar grip maximizes natural grip strength by accounting for these differences in individual fingers. Current handlebar grip designs with a constant diameter, such as the handlebar shown in FIGS. 3 and 4, fail to maximize the efficiency of natural grip strength, leaving riders more susceptible to fatigue, injury, and involuntarily releasing hold of their bike. It is well known and practiced to provide patterns and surface projections for handlebar grips to reduce potential of grip slippage by a riders hands. However, the hyperbolic tapered design of the present invention prevents slippage and injury by effectively reducing radial deviation of the wrist and improving grip strength by optimizing properties based off of the length-tension relationship.

### LISTING OF RELATED ART

US20140116196A1 by Rogers (pub. May 1, 2014) discloses a flared grip for bicycle or motorcycle handlebars.
U.S. Pat. No. 3,995,650A by DiVito (issued Dec. 7, 1976) discloses an adjustable positioned hand grip for canes, crutches, walkers and other ambulatory aids.
U.S. Pat. No. 7,044,020B2 by Rosenthal (issued May 16, 2006) discloses a tapered grip for motorcycle handlebar.
U.S. Pat. No. 5,979,015A by Tamaribuchi (issued Nov. 9, 1999) discloses an ergonomic hand grip and method of gripping.
U.S. Pat. No. 8,113,087 by Arnold (issued Feb. 14, 2012) discloses bicycle handle-bar grip.
US20170274957 by Krause et al. (pub. Sep. 28, 2017) discloses a “downhill grip for a bicycle.”

### SUMMARY OF THE INVENTION

In view of the foregoing, an object of this specification is to disclose handlebar grips that maximize natural grip strength. Another object of this specification is to disclose an injury preventative handlebar grip that optimizes stabilization by providing a means to reduce radial deviation of the wrist when grasping the handlebars and decreasing the wrists ability to deviate from this optimally desired neutral position.

In one embodiment, the handlebar grip exhibits a generally cylindrical body with an annular flanged distal end and a concaved hyperbolic outer cap end that results in an incrementally increasing diameter from a mid-point of the handlebar grip to the terminal end of the handlebar grip. This symmetrical concaved tapered design captures the varying optimal width/length spans for the individual fingers by gradually enlarging in diameter starting from a position that is offset from the inner open end, ending at the closed terminal end of the grip. Thereby maximizing the fingers' individual grip-strength contributions and producing more overall finger strength as a whole. The hyperbolically increasing diameter features different spans for the 3^{rd}, 4^{th} and 5^{th} digit fingers over the grip, with the largest grip-circumference closest to the terminal end of the grip at the gripping point of the little or 5th digit finger. A users positioning along the length of the grip is critical to optimize grip strength based on the graduated circumference of the grip.

Further, the added hyperbolic taper design results in an incrementally increased diameter projecting outwards from the mid-point of the grip. The hyperbolic taper design further provides a means to maintain the wrist in a neutral and properly aligned position. This proper position keeps the wrist from moving out of an ideal positioning or into a compromised position while still allowing vertical movements of the sagittal plane in relation to the wrist and forearm to accommodate for both seated and standing positions when grasping the handlebars.

Another object of the specification is to prevent involuntarily slippage of a user's grip in both an inward and outward direction. This outward limit is accomplished in a similar manner as the inner annular flange that projects radially outwards at the first open end to block inward sliding of a driver's hand off of a handlebar grip. The outward limit is similarly accomplished by the radial concave or hyperbolic taper design which operates to limit a driver's hand from sliding outward over the terminal end of the grip. The outward limit or sliding movement of a user's hand is further assisted through the grips hyperbolic taper via promotion of optimal grip strength in the 3^{rd} 4^{th}, and 5^{th} digit fingers.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a diagram of a rider in an aggressive or standing position;

FIG. 2 is a diagram of a rider in a relaxed or seated position;

FIG. 3 is a front view of a plain handlebar 2000;

FIG. 4A is an exemplary view of a prior art and conventional handlebar grip 1000;

FIG. 4B is another exemplary view of a prior art conventional handlebar grip;

FIG. 5 is a perspective view of a preferred handlebar grip; and,

FIG. 6 is an orthogonal view of the handlebar grip from the left;

FIG. 7 is an orthogonal view of the handlebar grip from the right;

FIG. 8 is an orthogonal view of the handlebar grip from the back;

FIG. 9 is an orthogonal view of the handlebar grip from the front; and

FIG. 10 is a side dimensional view of the handlebar grip;

FIG. 11 is a cross section of the handlebar grip along line A-A in FIG. 10.

FIG. 12 is an environmental view of the handlebar grip;

FIG. 13 is an environmental view of the handlebar grip

FIG. 14 is a perspective view of the handlebar grip;

FIG. 15 is a dimensional view of the handlebar grip;

FIG. 16 is another dimensional view of the handlebar grip; and,

FIG. 17 is a contextual view of the handlebar grip.

In the figures, the following reference numerals represent the associated components of the disclosed apparatus:
1000—traditional grip
   1100—cylindrical body
   1200—cap end
   1300—flanged end
2000—handlebars
3000—rider's hand or wrist
4000—hyperbolic grip
   4100—cylindrical body
   4200—hyperbolic cap end
   4300—flanged end
      4350—hollow interior

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed generally is a hyperbolic handlebar grip. Suitably, the hyperbolic handlebar grip defines a sleeve for the distal end of a handlebar and includes a cylindrical body that features on one end a flange and on the other end a hyperbolic end cap. In use, the hyperbolic handlebar grip maximizes natural grip strength and optimizes stabilization by providing a means, through design, to reduce radial deviation of the wrist when grasping the handlebars and decreasing the wrists ability to deviate from a neutral position. The handlebar grip further includes structures for retaining a user's hand on the grip by preventing outward or inward sliding of the users' hand toward the inner and outer terminal ends of the grip. The more specific aspects of the disclosed device are described below with reference to the appended figures.

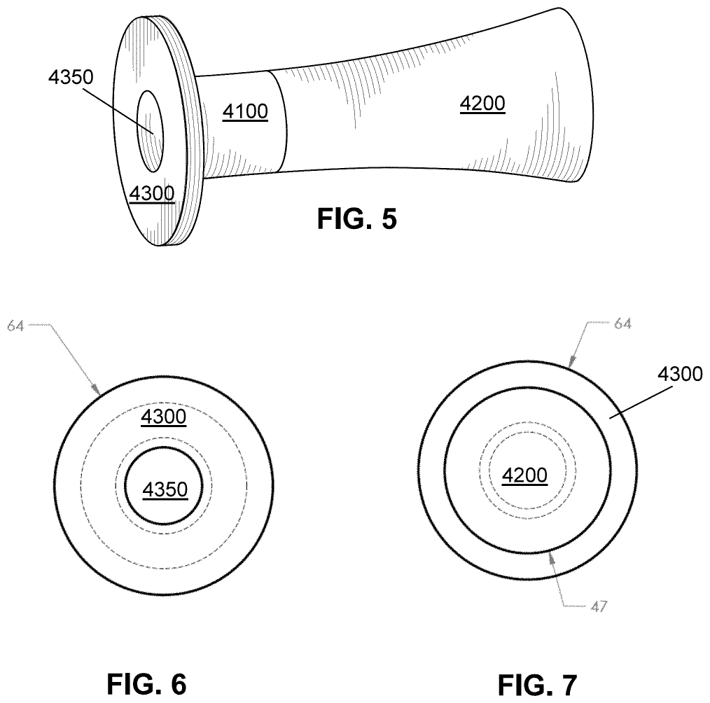

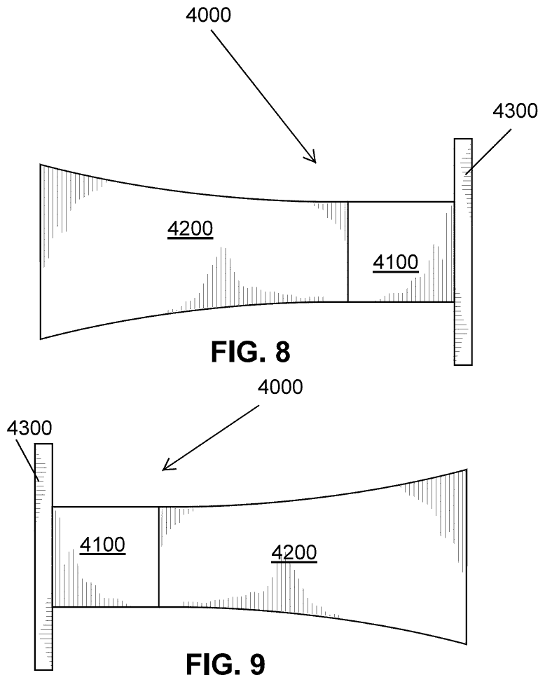

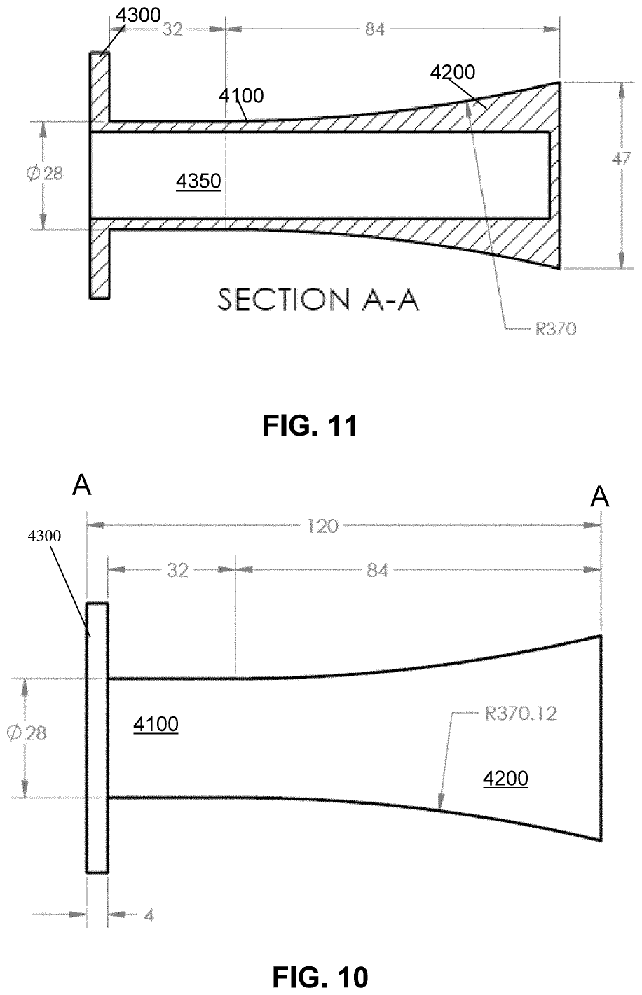

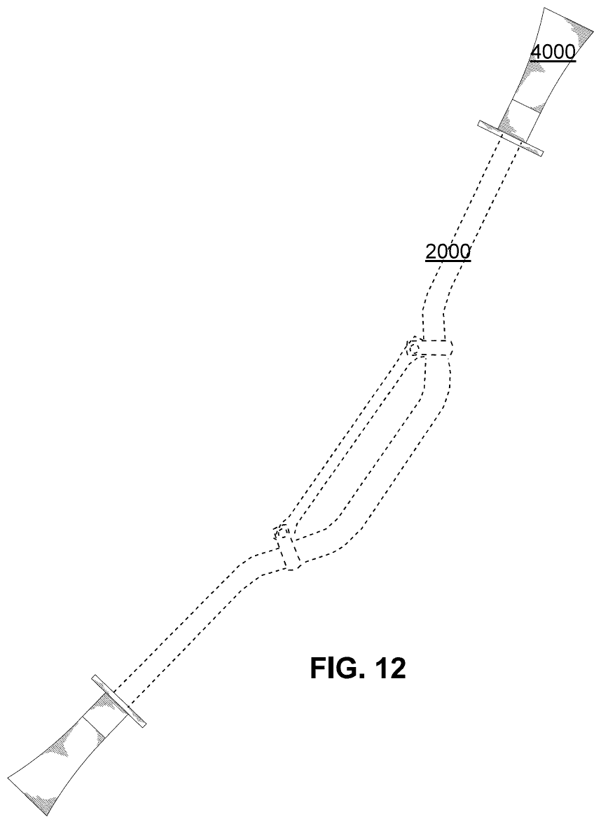

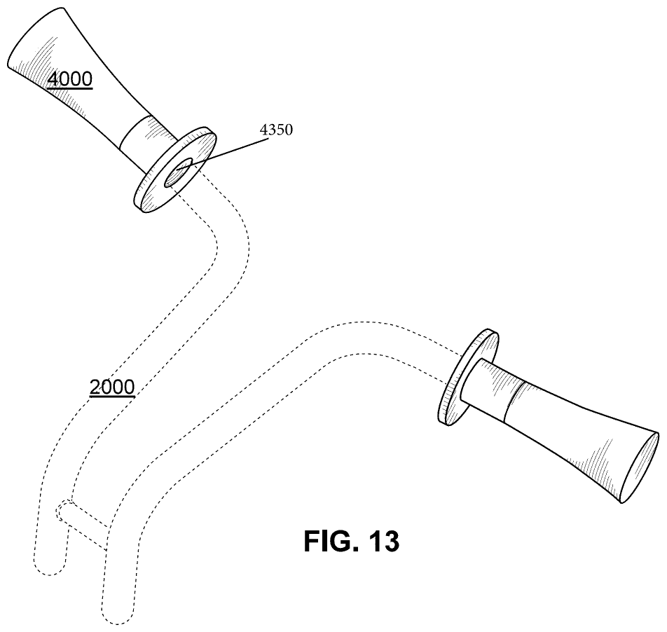

FIG. 5 is a perspective view of a preferred embodiment of the hyperbolic handlebar grip 4000. FIGS. 6 through 9 are respectively a left view, right view front view and back view of the hyperbolic handlebar grip 4000 of FIG. 5. FIGS. 10 and 11 show a cross-section of the handlebar grip 4000 of FIGS. 5 through 9. As shown in these figures collectively, the handlebar grip comprises a flange end 4300, a cylindrical body portion 4100, and a hyperbolic cap end portion 4200. Suitably, the flange end 4300, cylindrical portion 4100, and hyperbolic portion 4200 define a sleeve with a hollow interior 4350 that may be penetrated snugly by a distal end of a handlebar 2000 (FIGS. 12 and 13).

In the context of FIGS. 12 and 13, the hyperbolic handlebar grip 4000 is comprised of a hollow cylindrical body 4100 and hyperbolic cap 4200 that defines a non-rotatable sleeve-like cap for the distal end of a handlebar 2000. Suitably, the grips 4000 are made of flexible or cushion material, like rubber, and they have a hollowed-out interior that opens out to one flanged end 4300 of the grip 4000. Handlebars 2000 are outfitted with the grip 4000 by inserting the handlebar 2000 into the hollowed-out interior 4350 of the grip 4000 until the handlebar 2000 internally abuts the hyperbolic cap end 4200 of the grip 4000.

Suitably, the grip 4000 features a constant diameter cylindrical outer surface of the cylindrical body 4100 for, in a preferred embodiment, about 30 to 70 millimeters, optimally 32 millimeters, from the flanged end 4300 before the outer surface transitions from cylindrical to hyperbolic pseudo-cone that defines the hyperbolic cap end 4200 by tapering outwardly with a gradually increasing diameter until termination of the grip. In a preferred embodiment shown in FIGS. 10 and 11, the cylindrical body 4100 has a diameter of 28 millimeters before transitioning to the hyperbolic end cap 4200 with a diameter tapering at a hyperbolic arc of R370 from 28 millimeters at the infection point to 47 millimeters at the terminal end. Suitably, the grip may be made of rubber or silicone and feature a non-slip or tractioned surface defined by designs/layer projections to increase the friction of a user's grip and thereby minimize slippage.

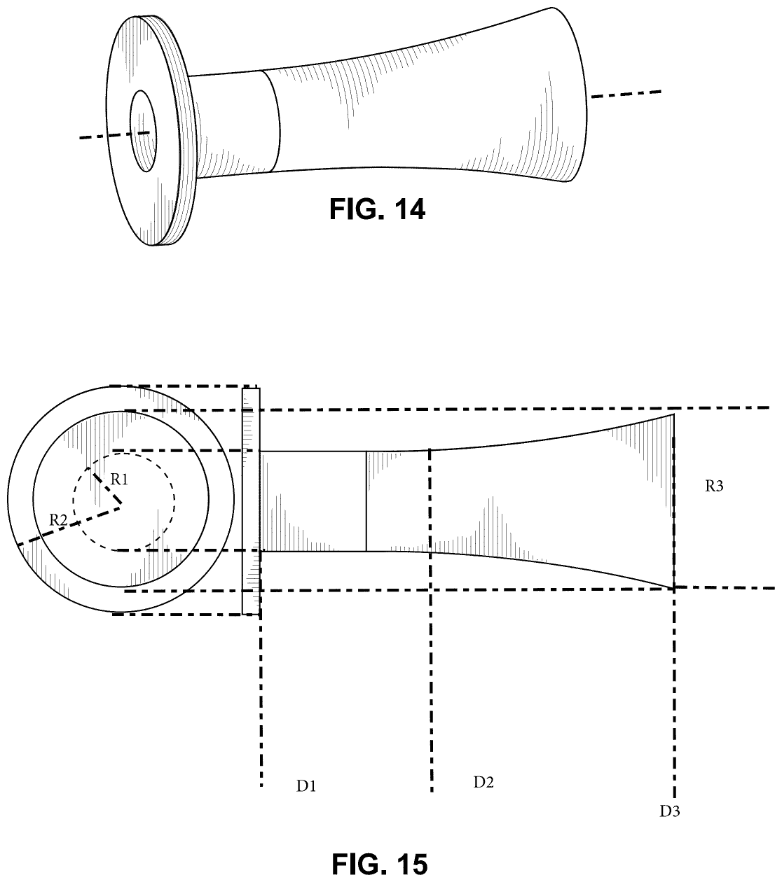

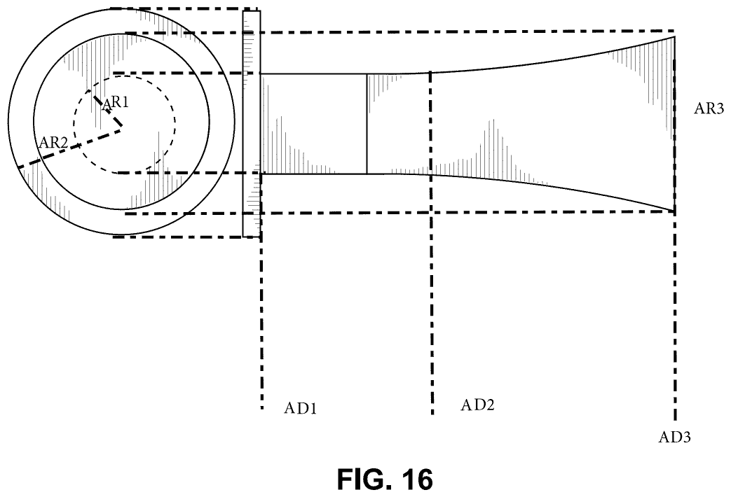

FIGS. 14, 15, and 16 show side views of the handlebar grip and demonstrative views of the inner annular end showing the handlebar opening of the grip. FIG. 15 shows minimal measurements for both (a) the radiuses of the handlebar grip (R1), inner annular flange (R2), and capped end (R3) and (D) for the length of the handlebar grip (D1, D2, D3). These figures and dimensions can be used to derive the angular changes that accompany the radial variations inherent to the hyperbolic arc of the end cap (R1 to R3 across D1 to D3). FIG. 16 shows the maximal measurements for both (i) the radiuses of the handlebar grip (AR1), inner annular flange (AR2), and capped end (AR3) and (ii) for the length of the handlebar grip (AD1, AD2, AD3). These figures and dimensions can be used to derive the angular changes that accompany the radial variations inherent to the hyperbolic arc of the end cap (AR1 to AR3 across AD2 to AD3). Referring to those figures, the handlebar opening R1 is 10 millimeters. The inner flange radius R2 ranges from 24 millimeters to 36 millimeters, optimally 32 mm. The radius of the flange or inner end of the grip body (R1) is preferably 14 millimeters. The tapered end radius ranges from 17 millimeters to 26 millimeters, optimally 23.5 millimeters. The length of the handlebar grip (D1, D2, D3), including the inner flange, ranges from 110 millimeters to 130 millimeters, with an optimal length of 120 millimeters. As shown in the preferred figures, the length of the handlebar grip is divided in to three portions. The first portion D1, is the length of the inner annular flange (approx. 4 mm). The second two portions meet at a transition or infection point (the location of D2) that triggers hyperbolic tapering of the grip to the terminal end (D3). The second length portion (point D1 to point D2) of the handlebar grip preferably ranges from 30 to 70 millimeters, with an optimal length of 32 millimeters. The second length portion (point D2 to point D3) of the handlebar grip ranges from 46 to 86 millimeters, with an optimal length of 84 millimeters.

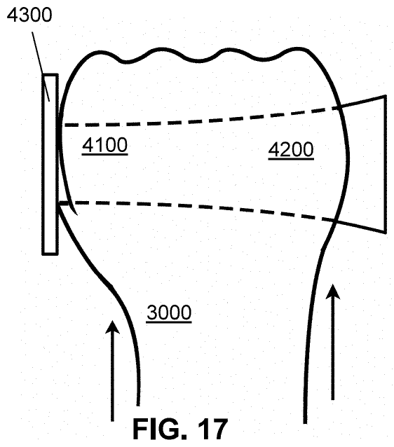

Referring to back to FIGS. 10 and 11 in the context of FIGS. 14, 15 and 16, the hyperbolic grip 4000 contains a hollow cylindrical bore 4350 projecting radially outwards from the flange open end 4300, meeting a closed hyperbolic cap end 4200 which is considered the terminal end of the grip 4000. The flange end 4300 suitably has an average radius (R2, FIGS. 14-16) of 32 mm projecting radially outwards at the cylindrical body 4100 which is to provide an inner limit for a rider's hand (See FIG. 17). The flange 4300 meets the handle portion 4100 (at point D1 FIGS. 14-16) on the cylindrical body at a perpendicular orientation, in which the body 4100 then projects outwards horizontally or laterally from the flange 4300 (at point D1 FIGS. 14-16) for an average of 32 mm, from the inside of the flange 4300 to a merger with the end cap 4200 (at point D2, FIGS. 14-16).

As shown in FIG. 10, the end cap 4200 merges with the body 4100 at 32 mm away from the inner flange 4300 (at point D2, FIGS. 14-16). Said point of merger is an infection point (at point D2 FIGS. 14-16) where the diameter of the grip begins to gradually enlarge in a symmetrically concave taper or hyperbolic pseudo-cone fashion. The taper or hyperbolic arc (e.g., R370) is continued in a gradual and constant progressive fashion starting at infection point D2 with a beginning diameter of 28 mm for the remaining length of the grip (e.g., 84 mm) until a diameter of 47 mm at the terminal end of the grip. The overall length of the grip 4000 including the inner flange 4300 has an outer length of 110-130 mm, and optimally 120 mm.

The object of the variations from the distance of the inner flange 4300 to the first inner infection point D2 where said concave begins to enlarge, as well as the overall outer dimensions is to factor any individuals hand size which includes hand diameter, grip size, and optimal finger length all of which contribute to grip strength. With these size variances we can account for small, medium, and large hands, as well as both male, female, and children anatomy. It is important that with these variances, radial deviation is reduced promoting neutral wrist alignment and optimal grip span is achieved maximizing natural grip strength for optimal benefits and use.

### Example 1

Cavity 4350 radius—10 mm;

### R1-14 mm;

### R2-32 mm;

### R3—23.5 mm;

### D1—4 m

### D2—32 mm;

### D3-84 mm;

Hyperbolic arc—R370

FIG. 17 shows a contextual view of the hyperbolic grip. It also shows an environmental view of the handlebar grip 4000. In use, the handlebar grip design reduces redial deviation of the wrist when a user adjusts between sitting and standing positions. The flange end 4300 defines an annular flange projecting radially and symmetrically outwards from around the opening of the interior cavity 4350). The annular flange 4300 is intended to provide an inner limit for a driver's hand 3000 wherein his/her forefinger and thumb encircle the grip and are blocked from advancing or floating toward the bare handlebar 2000 by the flanged end of the grip 4350. The hyperbolic flange end 4200 suitably biases the wrist to a more neutral position and reduces radial deviation. Additionally, the hyperbolic cap end 4200 retains the hand from floating outwardly.

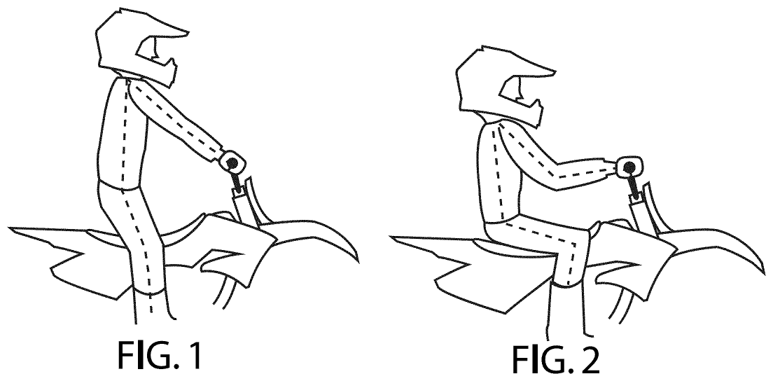

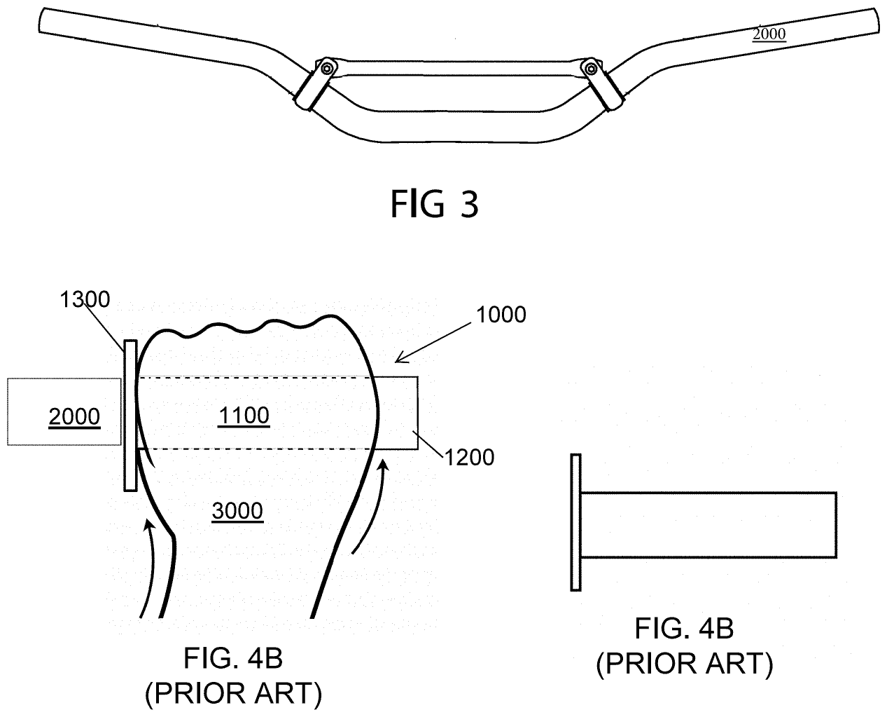

The radial taper or hyperbolic arc design conforms in a complete 360 degree circular symmetrical motion projecting outwards. This projection continues the remaining width of the grip and is not just a front facing 180 degree palm placement as seen in previous art/designs. The benefit for doing this in such a radial fashion is that since grips are mounted non rotatable the driver can readjust to accommodate for both sitting and standing positions when operating the motorcycle (FIGS. 1 and 2). With these adjustments it is important that the same benefits of reduced radial deviation and optimal grip span is achieved in all positions.

It is also known to provide the outer layer of such grip with traction or otherwise projections distributed in a pattern over external surfaces of the grip. Indeed, the provision of such patterns or surface projections which only project from the surface of something, is well known general knowledge for all types of handlebar grips. These tractions or projections are intended to reduce potential for slippage by the driver's hands. Said design of concave grip is not intended to compete against other designs for surface design and texture to improved drivers grip. The purpose of this disclosure is to describe grips which reduce radial deviation of the wrist and improve grip span strength based off of length tension relationship properties.

In an alternative embodiment, the hyperbolic grip may be used on other motor vehicles and equipment exhibiting handlebar or hand grips where increased grip strength and/or reduced radial deviation is desired, such as tennis racquets, exercise equipment, snowmobiles, quads, bicycles, or jet skis.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or Inure,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A handlebar grip comprising:
a flange;
a cylindrical body;
a hyperbolic pseudo-cone cap end;
wherein the flange, cylindrical body, and hyperbolic pseudo-cone cap end are assembled as a single unit with a hollow coaxial interior that opens to define a sleeve for the terminal end of a handlebar; and,
Where the external surface of the cylindrical body seamlessly transitions to the external surface of the hyperbolic pseudo-cone cap end so that the surface tapers outwardly according to a hyperbolic arc until a terminal end of the hyperbolic pseudo-cone cap end.

2. The handlebar grip of claim 1 where the diameter of the cylindrical body is 28 millimeters.

3. The handlebar grip of claim 2 where the diameter of the terminal end of the hyperbolic pseudo-cone cap end is 47 millimeters.

4. The handlebar grip of claim 3 where the hyperbolic arc is R370.

5. A method of riding a motorcycle comprising the steps of:
a. Positioning a thumb and an index finger of a rider around a cylindrical body of a handlebar grip;
b. Positioning at least the 5^{th} digit finger of a rider around a hyperbolic pseudo-cone cap end of the handlebar grip.

6. The method of claim 5 where the diameter of the cylindrical body is 28 millimeters.

7. The method of claim 6 where the diameter of a terminal end of the hyperbolic pseudo-cone cap end is 47 millimeters.

8. The method of claim 7 where a hyperbolic arc of the hyperbolic pseudo-cone cap end is R370.

9. A handlebar grip defined at a terminal end by a hyperbolic pseudo-cone.

10. The handlebar grip of claim 9 featuring a cylindrical body extending from the hyperbolic pseudo cone.
